(19) United States
(12) Patent Application Publication
(10) Pub. No.: US 2009/0197239 A1
(43) Pub. Date: Aug. 6, 2009

(54) Ching-Min Huang Education System

(76) Inventor: Ching-Min Huang, Tainan County (TW)

Correspondence Address: CHING-MIN HUANG, 3F, NO. 5, ALLEY 47, LN. 76, JHONGSIAO RD.,, YONGKANG CITY, (R.O.C.), TAINAN COUNTY, 710, TW

(21) Appl. No.: 12/210,210

(22) Filed: Sep. 14, 2008

(51) Int. Cl. G09B 19/00

(52) U.S. Cl. 434/433

(57) ABSTRACT

The proposed new education system, C.-M. Huang Education System, is according to the “Education Theory of Ching-Min Huang—General Education and Specialized Learning”.

### BRIEF SUMMARY

Confucius' principle of individualized instruction can not be applied to the whole education system due to the limitation of human resources. Therefore, this school system will clearly define where and how to apply the principle. General education emphasizes broad learning, which allows students to discover their interests before they decide to specialize in one area. The elementary school curriculum focuses on basic subjects; these are divided into two groups according to students' interests: the Natural Science Group and the Social Science Group. Both groups provide basic courses, with more time for subjects of interest. The first seven semesters of high school still focus on basic subjects, but in the last four semesters students can choose a particular subject as their area of expertise, which must be included in one of the three programs in college. College education allows students to choose from among three programs instead of solely focusing on one from the beginning, which often restrains students' development and leads to a single area of expertise on the job. All three programs can be in the same field or different fields.

### BACKGROUND

The educational theory of individualized instruction was created by Confucius (B.C. 551-479), a Chinese philosopher and educator in the Spring and Autumn/Warring States Period.

### DETAILED DESCRIPTION

### Chapter One: Education System

### Article 1 (Definitions of the Education System)

1. The education system comprises elementary school, high school and college, successively.
2. The programs of elementary school, high school and college are designed in accordance with the educational theory of “general education and specialized learning” (Note 1). “General education” offers general knowledge in all fields, while “specialized learning” means acquiring knowledge in a specific area.
3. This education system is comprised of “general education and specialized learning” (95%) and “individualized instruction” (5%). The percentages represent the applicable ranges.
   (1) Elementary schools, high schools and colleges adopt the “general education and specialized learning” theory;
   (2) Gifted education and special education in elementary schools and high schools as well as graduate schools adopt both “general education and specialized learning” and “individualized instruction.”
   (3) Doctoral level education adopts the “individualized instruction” theory.

### Article 2 (Elementary School Qualification)

1. Elementary School
   (1) Enrollment is open to children six years old and above;
   (2) All courses must be completed in six years;
   (3) Graduate essay.
      i. Natural Science Group
         1. Using the software (physics, chemistry, engineering, etc.) developed by high school students or free software to conduct simple research;
         2. Conducting mathematic research that is higher than the elementary level, progressing from the easy to the difficult;
         3. Conducting research on natural science (physics, chemistry, ecology, etc.) that is higher than the elementary level, progressing from the easy to the difficult;
         4. Medical science, engineering, information science, agriculture, fisheries, etc;
         5. Others.
      ii. Social Science Group
         1. Literature, history, philosophy, fine arts, economics, business, folk custom, cinema, TV program, other social studies, etc.
         2. Research on elementary school students' essays (Note 2);
         3. Research on additions and deletions of elementary school textbooks (Note 3);
         4. Others.
   (4) Drop-outs will be assisted by the national education authority to continue their schooling.
2. Elementary School (Primary Specialized Program)
   (1) Enrollment is open to citizens over 12 years old;
   (2) At least one specialized program, which can be taken in the evenings, on weekends or during winter and summer vacations;
   (3) Students who take primary specialized diploma programs are eligible to be instructed by elementary school teachers on writing graduate essays, and will be awarded diplomas in primary specialized programs after passing oral examinations;
   (4) Students who do not write graduate essays will be awarded certificates in primary specialized programs.

### Article 3 (High School Qualification)

1. General High School
   (1) The general high school curriculum must be completed in six years;
   (2) At least one specialized program;
   (3) At least one national certificate, which can be replaced by any other forms approved by the national education authority;
   (4) At least one foreign language;
   (5) Graduate essay (Note 4).
2. Fine Arts High School
   (1) The general high school curriculum and the fifth- and sixth-grade curriculum must be completed in eight years;
   (2) At least one fine arts program;
   (3) At least one foreign language;
   (4) Graduate essay, which can be replaced by any other forms approved by the national education authority.
3. Music High School
   (1) The general high school curriculum and the fifth- and sixth-grade curriculum must be completed in eight years;
   (2) At least one music program;
   (3) At least one foreign language;
   (4) Graduate essay, which can be replaced by any other forms approved by the national education authority.
4. Sports High School
   (1) The general high school curriculum and the fifth- and sixth-grade curriculum must be completed in eight years;
   (2) At least one sports program;
   (3) At least one foreign language;
   (4) Graduate essay, which can be replaced by any other forms approved by the national education authority.
5. General, Fine Arts, Music or Sports High School (Secondary Specialized Program)
   (1) Enrollment is open to citizens over 23 years old who have graduated from elementary schools;
   (2) At least one specialized program, which can be taken in the evenings, on weekends or during winter and summer vacations;
   (3) Students who take secondary specialized diploma programs are eligible to be instructed by high school teachers on writing graduate essays, and will be awarded diplomas in secondary specialized programs after passing oral examinations;
   (4) Students who do not write graduate essays will be awarded certificates in secondary specialized programs.
6. Drop-outs will be assisted by the national education authority to continue their education.

### Article 4 (Bachelor's Degree)

7. University
   (1) At least three programs must be completed in five years; the first program must cover the area of high school subject tests;
   (2) Extended high school foreign language courses; students can take the courses at other universities if the current university does not offer such courses;
   (3) Bachelor's degree thesis;
   (4) Internship at associated institutions for one and a half years. (Note 5)
8. Military College
   (1) At least two of the required military programs must be completed in eight years;
   (2) The third program must be taken in another college;
   (3) Extended high school foreign language courses;
   (4) Bachelor's degree thesis;
   (5) One year of internship at associated institutions (Note 5);
   (6) Drop-outs will be assisted by the national education authority to continue their education.
9. Police College
   (1) At least two of the required police programs must be completed in eight years;
   (2) The third program must be taken in other colleges;
   (3) Extended high school foreign language courses;
   (4) Bachelor's degree thesis;
   (5) One year of internship at associated institutions (Note 5);
   (6) Drop-outs will be assisted by the national education authority to continue their education.
10. University and Technical College (Advanced Specialized Programs)
   (1) Enrollment is open to citizens over 28 years old and have graduated from high school or those who have earned diplomas in secondary specialized programs;
   (2) At least one specialized course, which can be taken in the evenings, on weekends or during winter and summer vacations;
   (3) Students who take advanced specialized degree programs are eligible to take university or technical college preparatory examinations to participate in research projects and write degree theses, and will earn degrees in advanced specialized programs after passing oral examinations;
   (4) Students who do not write degree theses will be awarded certificates in advanced specialized programs;
   (5) Internship at associated institutions for one and a half years. (Note 5)

### Article 5 (Master's Degree)

1. Seminar is required;
2. Master's degree thesis.

### Article 6 (Doctorate)

1. Seminar is required;
2. Doctoral dissertation.

### Article 7 (Semester)

1. There are two semesters in an academic year; five months (22 weeks) in a semester; one month (four weeks) each of winter and summer vacations.
2. The first semester starts on September 1^{st} and ends on January 31^{st}
3. The winter vacation starts on February 1^{st} and ends on February 28^{th} (or 29^{th}).
4. The second semester starts on March 1^{st} and ends on July 31^{st}.
5. The summer vacation starts on August 1^{st} and ends on August 31^{st}.
6. Graduation ceremony takes place between 1^{st} and 31^{st} of August.
7. High school cooperative education is implemented between the 8^{th} and 11^{th} semesters (please refer to Appendix 4).

### Chapter Two: Examinations

### Article 8 (National Examinations)

1. Elementary School
   (1) National Elementary School Entrance Examination
   (2) National Elementary School First Academic Attainment Test
      (After the 4th semester, as a foundation for class grouping (Note 6) and group division)
   (3) National Elementary School First Aptitude Test
      (Before the 5th semester, as a reference for choosing subjects)
   (4) National Elementary School Second Academic Attainment Test
      (After the 8th semester, enrollment of new students in fine arts, music and sports high schools)
   (5) National Elementary School First Intelligence Test
      (Before the 9th semester, as a reference for elementary gifted education)
   (6) National Elementary School Second Aptitude Test
      (Before the 9th semester, as a reference for choosing subjects)
   (7) Elementary School Essay Defense
      (In the 11th semester, graduate essay defense)
   (8) National High School Three-Subject Test
      (Before the 12th semester, subject test for entering high school)
   (9) Elementary Inter-School Essay Competition
      (In the 12th semester, inter-school essay competition)
   (10) Level Two National Elementary School Essay Competition
      (In the 12^{th} semester, national essay competition)
   (11) Level One National Elementary School Essay Competition
      (In the 12th semester, granting “Elementary Essay Student,” admitting to high school)
   (12) National Elementary School Second Intelligence Test
      (After the 12^{th} semester, as a reference for high school gifted education)
   (13) National High School Entrance Examination
      (After the 12^{th} semester, high school entrance examination)
2. General High School
   (1) National High School First Aptitude Test
      (Before the 1^{st} semester, as a reference for choosing expertise)
   (2) National High School First Academic Attainment Test
      (After the 4^{th} semester, as a foundation for class grouping (Note 6))
   (3) National High School Second Aptitude Test
      (After the 7^{th} semester, as a reference for choosing expertise)
   (4) National High School Second Academic Attainment Test
      (After the 7^{th} semester, enrollment of new students in military and police colleges)
   (5) High School Essay Defense
      (In the 11^{th} semester, graduate essay defense)
   (6) National Three-Subject College Entrance Test
      (Before the 12^{th} semester, subject test for entering college)
   (7) High School Inter-School Essay Competition
      (In the 12^{th} semester, inter-school essay competition)
   (8) Level Two National High School Essay Competition
      (In the 12^{th} semester, national essay competition)
   (9) Level One National High School Essay Competition
      (In the 12^{th} semester, granting “High School Essay Student,” admitting to college)
   (10) National College Entrance Examination
      (After the 12^{th} semester, college entrance examination)
3. Fine Arts, Music and Sports High School
   (1) National High School Second Academic Attainment Test
      (After the 11^{th} semester, as a foundation for second specialized program)
   (2) High School Essay Defense
      (In the 15^{th} semester, graduate essay defense)
   (3) National Technical College Entrance Test
      (Before the 16^{th} semester, subject test for entering college)
   (4) Level Two National High School Essay Competition
      (In the 16^{th} semester, national essay competition)
   (5) Level One National High School Essay Competition
      (In the 16^{th} semester, granting “High School Essay Student,” admitting to college)
   (6) National College Entrance Examination
      (After the 16^{th} semester, college entrance examination)
4. General High School (Cooperative Education)
   (1) National High School First Aptitude Test
      (Before the 1^{st} Semester, as a Reference for Choosing Expertise)
   (2) National High School First Academic Attainment Test
      (After the 4^{th} semester, as a foundation for class grouping)
   (3) National High School Second Aptitude Test
      (After the 7^{th} semester, as a reference for choosing expertise)
   (4) National High School Second Academic Attainment Test
      (After the 7^{th} semester, enrollment of new students in military and police colleges)
   (5) National Three-Subject College Entrance Test
      (Before the 12^{th} semester, subject test for entering college)
   (6) National College Entrance Examination
      (After the 12^{th} semester, college entrance examination)
5. University and Technical, Military and Police College
   (1) Bachelor's Degree
      i. College Preparatory Test
         (After the End of the 1^{st} Semester)
      ii. Bachelor's Degree Thesis Defense
         (Within 3 weeks after applying for thesis defense)
      iii. Level Two National Bachelor's Degree Thesis Competition
         (In the 2^{nd} semester, national thesis competition)
      iv. Level One National Bachelor's Degree Thesis Competition
         (In the 2^{nd} semester, granting “Thesis Bachelor,” admitting to graduate school)
      v. College Associated Institution Internship Oral Examination
         (Within 3 weeks after applying for internship oral examination)
      vi. Graduate School Application with Theses
         (In the 2^{nd} semester)
      vii. Graduate School Entrance Examination
         (In the 2^{nd} semester)
   (2) Master's Degree
      i. Master's Degree Thesis Defense
         (Within 3 weeks after applying for thesis defense)
      ii. Level Two National Master's Degree Thesis Competition
         (In the 2^{nd} semester, national thesis competition)
      iii. Level One National Master's Degree Thesis Competition
         (In the 2^{nd} semester, granting “Thesis Master,” admitting to doctoral program)
      iv. Doctoral Program Application with Theses
         (In the 2^{nd} semester)
      v. Doctoral Program Entrance Examination
         (In the 2^{nd} semester)
   (3) Doctorate
      i. Doctoral Dissertation Defense
         (Within 3 weeks after applying for dissertation defense)
      ii. National Doctoral Dissertation Competition
         (In the 2^{nd} semester, granting “Dissertation Doctor”)

### Article 9 (Test Subjects)

1. National Elementary School First Academic Attainment Test (the numbers represent scores)
   (1) Common Subjects: Chinese (100), mathematics (100), science (100), social studies (100) and legal studies (50).
   (2) Natural Science Group: Mathematics scores and science scores are weighted 50%, respectively, in this test.
   (3) Social Science Group: Chinese scores and social studies scores are weighted 50%, respectively, in this test.
2. National Elementary School Second Academic Attainment Test
   (1) Common Subjects: Chinese (100), mathematics (100), science (100), social studies (100), legal studies (50), health education (50), industry (50), commerce (50), agriculture and fisheries (50), and information science (50).
   (2) Natural Science Group: Mathematics scores and science scores are weighted 50%, respectively, in this test.
   (3) Social Science Group: Chinese scores and social studies scores are weighted 50%, respectively, in this test.
3. National High School Three-Subject Test
   (1) Common Subjects: Chinese (200) and mathematics (200).
   (2) Natural Science Group: Science (200).
   (3) Social Science Group: Social studies (200).
4. National High School Entrance Examination
   (1) Common Subjects: Chinese (150), mathematics (150), and comprehensive subjects (legal studies, health education, industry, commerce, agriculture and fisheries, and information science) (150).
   (2) Natural Science Group: Science (150) and social studies (100).
   (3) Social Science Group: Science (100) and social studies (150).
5. National High School First Academic Attainment Test Chinese (100), foreign language (100), mathematics (100), fundamental physics (100), fundamental chemistry (100), fundamental history (50), fundamental geography (50), legal studies (50), and health education (50).
6. National High School Second Academic Attainment Test Common Subjects Chinese (100), foreign language (PR/100) and mathematics (100).
   (1) First Group: Fundamental physics (125), fundamental chemistry (125), computer science (50), and comprehensive subjects I (100).
   (2) Second Group: Fundamental history (100), fundamental geography (100), legal studies (100) and comprehensive subjects II (100).
   (3) Third Group: Fundamental biology (100), life science (100), health education (100) and comprehensive subjects III (100).
   (4) Fourth Group: Economics (100), business management (100), financial management (100) and comprehensive subjects IV (100).
7. National Three-Subject College Entrance Test Specialized subject I (200), specialized subject II (200) and specialized subject III (200).
8. National College Entrance Examination Common Subjects: Chinese (100), foreign language (PR/100), foreign language composition (PR/100) and special fields of study (100).
   (1) First Group: Fundamental physics (125), fundamental chemistry (125), computer science (50), and comprehensive subjects I (100).
   (2) Second Group: Fundamental history (100), fundamental geography (100), legal studies (100), and comprehensive subjects II (100).
   (3) Third Group: Physics & chemistry (120), biology & life science (120), health education (60), and comprehensive subjects III (100).
   (4) Fourth Group: Economics (100), business management (100), financial management (100) and comprehensive subjects IV (100).

### Article 10 (Admission Tracks and Number of Offers)

1. High School (base on personal preferences)
   (1) Admission via National High School Three-Subject Test (including technical tests) accounts for ⅓ of the total number of high school students enrolled.
   (2) Admission via Level One National Elementary School Essay Competition accounts for ⅓ of the total number of high school students enrolled.
   (3) Admission via National High School Entrance Examination accounts for ⅓ of the total number of high school students enrolled.
2. College (base on personal preferences)
   (1) Admission via National Three-Subject College Entrance Test (including technical tests) and national or international specialized or technical skills competitions accounts for ⅓ of the total number of college students enrolled.
   (2) Admission via Level One National High School Essay Competition accounts for ⅓ of the total number of college students enrolled.
   (3) Admission via National College Entrance Examination accounts for ⅓ of the total number of college students enrolled.
3. Graduate School
   (1) Admission via Level One National Bachelor's Degree Thesis Competition accounts for ⅖ of the total number of graduate school students enrolled (base on personal preferences).
   (2) Admission via thesis accounts for ⅖ of the total number of graduate school students enrolled (independent recruitment).
   (3) Admission via Graduate School Entrance Examination accounts for ⅕ of the total number of graduate school students enrolled (independent recruitment).
4. Doctoral Program
   (1) Admission via Level One National Master's Degree Thesis Competition accounts for ⅖ of the total number of doctoral students enrolled (base on personal preferences).
   (2) Admission via thesis accounts for ⅖ of the total number of doctoral students enrolled (independent recruitment).
   (3) Admission via Doctoral Program Entrance Examination accounts for ⅕ of the total number of doctoral students enrolled (independent recruitment).

### Article 11 (School Tests)

1. Tests
   (1) Two tests are required before a midterm examination (which takes place at particular learning stages). Broad-ranged courses should have several tests (multiple of two), given separately in the forms of open-book tests and key-point tests.
   (2) The first test is an open-book test. Students can refer to their textbooks, notebooks and assignments during the test (Note 7).
   (3) The second test is a key-point test. Students can take down key points on given number of sheets and do the test (Note 7).
2. Midterm Examinations (Note 8)
   (1) Midterm examinations are closed-book examinations. Students cannot refer to books or notes during the examinations.
   (2) At least two midterm examinations in a semester are given on subjects with fewer than four credits.
   (3) At least three midterm examinations in a semester are given for six-credit subjects.
   (4) At least four midterm examinations in a semester are given for eight-credit subjects.
   (5) At least five midterm examinations in a semester are given for ten-credit subjects.

### Chapter Three: Faculty and Students

### Article 12 (Research Faculty) (Note 9)

1. Professorial Chairs
   (1) Level one to three; level one is untenured; level two and three are tenured positions. Professorial chairs are qualified to give lectures and organize research projects with professors or researchers;
   (2) Candidates with writings or dissertations at the equivalent level are qualified for the position of professorial chair;
   (3) Professorial chairs can direct degree students;
   (4) Professorial chairs have authority to approve research projects or review research reports for College Research Project Institution (Note 10);
   (5) Professorial chairs can be promoted or demoted every two years according to performance (new writings, dissertations, teaching and reputation). The assessment is decided by the research faculty. Each promotion or demotion should not be more than one level. Exceptions for special cases may exist.
2. Professors
   (1) Level one to twelve; all are qualified to give lectures and organize research projects with researchers. Level one to four is professor; level five to eight is associate professor; level nine to twelve is assistant professor;
   (2) Candidates with writings or dissertations at the equivalent level are qualified for the position of professor;
   (3) Professors can direct degree students;
   (4) Professors have authority to approve research projects or review research reports for College Research Project Institution (Note 10);
   (5) Professors can be promoted or demoted every two years according to performance (new writings, dissertations, teaching and reputation). The assessment is decided by the research faculty. Each promotion or demotion should not be more than three levels. Exceptions for special cases may exist.
3. Researchers
   (1) Level one to three. Researchers can organize research projects with associate professors or assistant professors;
   (2) Candidates with writings or theses/dissertations at equivalent level are qualified for the position of researcher;
   (3) Researchers can direct bachelor's degree students;
   (4) Researchers can be promoted or demoted every year according to performance (new writings, theses/dissertations, teaching and reputation). The assessment is decided by the research faculty. Each promotion or demotion should not be more than two levels. Exceptions for special cases may exist.
4. Associated Institution Professors
   (1) Level one to twelve; level one is a tenured position; the others are not. All are qualified to direct degree students who have passed the thesis defense;
   (2) Associated institution professors have authority to recognize the practical ability of degree students, and request students to make up for what they lack in professional knowledge by taking specified classes;
   (3) Associated institution professors can be promoted or demoted every two years according to performance (new writings, dissertations, teaching and reputation). The assessment is decided by the research faculty. Each promotion or demotion should not be more than three levels. Exceptions for special cases may exist.
5. High School Teachers
   (1) Level one to twelve; level one is a tenured position; the others are not;
   (2) Candidates who have completed high school education programs or vocational education programs are qualified for the position of high school teacher;
   (3) High school teachers can direct high school students;
   (4) High school teachers can be promoted or demoted every year according to performance (new writings, theses/dissertations, teaching and reputation). The assessment is decided by the research faculty. Each promotion or demotion should not be more than two levels. Exceptions for special cases may exist.
6. Elementary School Teachers
   (1) Level one to twelve; level one is a tenured position; the others are not;
   (2) Candidates who have completed elementary school education programs are qualified for the position of elementary school teacher;
   (3) Elementary school teachers can direct elementary school students;
   (4) Elementary school teachers can be promoted or demoted every year according to performance (new writings, theses/dissertations, teaching and reputation). The assessment is decided by the research faculty. Each promotion or demotion should not be more than two levels. Exceptions for special cases may exist.
7. Faculty members whose fundamental theories, in their disciplines, are disproved and cannot retain their original academic reputation.
   (1) Professorial chairs will be demoted to professors of level eleven;
   (2) Professors of level one to four will be demoted to level twelve;
   (3) Professors of level five to eight will be demoted to researchers of level one;
   (4) Professors of level nine to twelve will be demoted to researchers of level two;
   (5) Researchers of level one and two will be demoted to level three.

### Article 13 (Degree Students)

1. Doctoral Students
   (1) Doctoral students can choose research projects, instructors (or researchers) and research subjects through program preparatory examinations. Students should audit classes or take courses when necessary;
   (2) Doctoral students can direct master's degree students or bachelor's degree students.
2. Master's Degree Students
   (1) Master's degree students can choose research projects, instructors (or researchers) and research subjects through program preparatory examinations. Students should audit classes or take courses when necessary;
   (2) Master's degree students can direct bachelor's degree students.
3. Bachelor's Degree Students
   (1) Bachelor's degree students can choose research projects, instructors (or researchers) and research subjects through program preparatory examinations. Students should take certain courses when necessary;
   (2) Students must take at least three programs, one of which should cover the area of high school subject tests;
   (3) Bachelor's degree students can direct high school students.
4. High School Students
   (1) Students must complete basic high school courses and at least one specialized program;
   (2) High school students can take college courses upon official review.
5. Elementary School Students
   (1) Students must complete elementary school courses.
      i. Third-grade students can choose among Natural Science, Social Science, Fine Arts, Music and Sports Groups according to their aptitude test results;
      ii. Fifth-grade students can choose either the Natural Science Group or Social Science Group according to their aptitude test results;
   (2) Elementary students can take high school courses upon official review.

### Chapter Four: Programs

### Article 14 (Courses and Credit Allocation) (Note 11)

1. Refer to Appendix 1 for elementary school courses and credit allocation.
2. Required high school courses and credit allocation
   (1) Refer to Appendix 2 for general high schools;
   (2) Refer to Appendix 3 for fine arts, music and sports high schools;
   (3) Refer to Appendix 4 for high school cooperative education.
3. Refer to Appendix 5 for required courses and credit allocation of universities and technical colleges;
4. Refer to Appendix 6 for required courses and credit allocation of military and police universities or colleges.

### Article 15 (Objectives of Research Education)

1. Gifted thesis research education allows one teacher to instruct 5 students at most; general thesis research education allows one teacher to instruct 17 students at most.
2. Doctoral education: one professor can instruct at most 5 doctoral students; master's degree education: one professor can instruct at most 17 graduate students; bachelor's degree education: one professor can instruct at most 32 college students. One professor can instruct several doctoral, master's degree and bachelor's degree students at the same time. According to the research education equivalent theory formula of this education system, 5 doctoral students equals 17 master's degree students or 32 bachelor's degree students. The optimal ratio of doctoral students to master's degree students to bachelor's degree students is 3:5:4 or 3:4:6.
3. All professors or teachers have specific research fields. Each high school and elementary school student has a particular instructor but can be advised by several teachers specializing in the same field. The level of research done by college students and high school students varies greatly; therefore, college students mainly conduct support research to learn about research fields at higher levels. Master's degree students have a better understanding of professional research and thus can conduct support and self-directed research. Doctoral students are expected to conduct independent research in the future; therefore doctoral education focuses on self-directed research. Students are advised by their instructors on research directions until they satisfy the goals of their research.
4. The primary difference in education between college students and master's and doctoral students is that college students conduct research assigned by several professors, while master's and doctoral students obtain individual instruction. This model allows college students to broadly learn several fields of study, from which they can choose a particular subject to conduct their self-directed research. This program reflects the implementation of “general education and specialized learning.” Master's degree students have generally understood the whole field. After choosing a particular subject of interest, they are co-instructed and -supervised by several professors although they already have one individual instructor, which reflects the implementation of “general education and specialized learning” and “individualized instruction.” Doctoral students receive one-on-one instruction but they are supervised and advised by several professors. This is also indicative of the implementation of “individualized instruction.”
5. The core purpose of “general education and specialized learning” is to discover students' interests. Students can learn a broad range of subjects before they choose one. This can prevent them from choosing the wrong subject and having to restart the whole process.
6. Each elementary school student is instructed by several teachers specializing in the same field. After their interests are found, a particular teacher will advise them on research directions and subjects. Students must write an essay of three pages or above, which can be evaluated as: a failed research, a non-original research or a research without any specific results. In any case, the reasons for failure and the whole research process must be clearly stated in the essay. Creative research results should be sent to high schools or colleges for review, and the students will be granted the privilege of entering high school and receiving gifted education.
7. Students who obtain outstanding IQ scores at the National Elementary School First Intelligence Test will receive a gifted essay research education. Several teachers in the same field will co-supervise a student and ensure that the student's research field is based on logic, space or geometry. Each student will be trained by a particular teacher to solve questions, ranging from easy to difficult. All the solved questions and the next level of the unsolved questions will constitute the scope of the graduate essay.
8. Elementary school students whose IQ is not higher than average but who have remarkable research abilities can be considered as gifted students and receive a gifted essay research education.
9. Each high school student is instructed by several teachers specializing in the same field. After their interests are found, a particular teacher will advise them on research directions and subjects. Students must write an essay of ten pages or above, which can be evaluated as: a failed research, a non-original research or a research without any specific results. In any case, the reasons for failure and the whole research process must be clearly stated in the essay. Creative research results should be sent to colleges for review, and the students will be granted the privilege of entering college.
10. Students who obtain outstanding IQ scores at the National High School Second Intelligence Test will receive a gifted essay research education. Students start their research from the first semester, seven semesters earlier than normal. Several teachers in the same field will co-supervise a student and ensure that the research field is based on logic, space or geometry. Each student will be trained by a particular teacher to solve questions, ranging from easy to difficult. At the end of the fifth semester, students will choose a subject for specialized training. All of the solved questions and the next level of the unsolved questions will constitute the scope of the graduate essay.
11. High school students whose IQ is not higher than average but who have remarkable research abilities can be considered as gifted students and receive a gifted essay research education.
12. Bachelor's degree students are co-instructed by research teams which will advise them on course directions and allocate research subjects. Students work with the teams to conduct supportive or original research.
13. Master's degree students are co-instructed and -supervised by research teams. Each student has a particular professor to advise the student on research directions and subjects. Students work with the teams and the professors to conduct original or creative research.
14. Doctoral students are co-supervised by research teams. Each student has a particular professor to advise the student on research directions. Students should propose an individual research subject and conduct creative research independently.

### Article 16 (Education Objectives)

1. Elementary school and the first to seventh semester of high school focus on basic subjects. The education objectives of each subject are determined by the national education authority.
2. The eighth to eleventh semester of high school focus on secondary specialized programs established by the national education authority.
3. Bachelor's degree students receive advanced specialized programs which are established by colleges and examined by the national education authority.
4. Master's degree students and doctoral students receive research education which is established by colleges and examined by the national education authority.

### Chapter Five: Academic Ranks

### Article 17 (Academic Ranks and Titles)

1. Elementary School Essay Student
   This title, conferred on students who win at the Level One National Elementary School Essay Competition, is the highest academic rank for elementary school students.
2. High School Essay Student
   This title, conferred on students who win at the Level One National High School Essay Competition, is the highest academic rank for high school students.
3. Thesis Bachelor
   This title, conferred on students who win at the Level One National Bachelor's Degree Thesis Competition, is the highest academic rank for college students.
4. Thesis Master
   This title, conferred on students who win at the Level One National Master's Degree Thesis Competition, is the highest academic rank for graduate school students.
5. Dissertation Doctor
   This title, conferred on students who win at the National Doctoral Dissertation Competition, is the highest academic rank for doctoral students.

APPENDIX 1
Elementary School Program

| | | General Courses | | | | Specialized Courses | | | | | | Essay | | |
|---|---|---|---|---|---|---|---|---|---|---|---|---|---|---|
| | | Term | | | | | | | | | | | | |
| Field | Subject | I | II | III | IV | V | VI | VII | VIII | IX | X | XI | Credit | Hour |
| Essay | Essay | | | | | | | | 0 | 2 | 2 | 2 | 6 | 132 |
| | Essay writing | | | | | | | | | 2 | | | 2 | 44 |
| Basic | National Language | 10 | 10 | 10 | 10 | 8 | 8 | 6 | 6 | 6 | 6 | 6 | 86 | 1892 |
| Subjects | Mathematics | 10 | 10 | 10 | 10 | 10 | 10 | 6 | 6 | 6 | 6 | 6 | 90 | 1980 |
| | Science/A | 8 | 10 | 10 | 10 | 10 | 10 | 10 | 10 | 6 | 6 | 6 | 96 | 2112 |
| | Science/B | 4 | 4 | 4 | 4 | 4 | 4 | 4 | 4 | 4 | 4 | 4 | 44 | 968 |
| | Social Studies/A | 8 | 10 | 10 | 10 | 10 | 10 | 10 | 10 | 6 | 6 | 6 | 96 | 2112 |
| | Social Studies/B | 4 | 4 | 4 | 4 | 4 | 4 | 4 | 4 | 4 | 4 | 4 | 44 | 968 |
| | Legal Studies | 2 | 2 | 2 | 2 | 1 | 1 | 1 | 1 | 1 | 1 | 1 | 15 | 330 |
| | Health Education | 2 | | | | 2 | | | | 2 | | | 6 | 132 |
| Specialized | Industry | | | | | | | 2 | 2 | 2 | 2 | 2 | 10 | 220 |
| Subjects | Commerce | | | | | | | 2 | 2 | 2 | 2 | 2 | 10 | 220 |
| | Agriculture & Fisheries | | | | | | | 1 | 1 | 1 | 1 | 1 | 5 | 110 |
| | Information Science | | | | | | | 4 | 4 | 2 | 2 | 2 | 14 | 308 |
| Fine Arts | Fine Arts | 1 | 1 | 1 | 1 | 1 | 1 | 1 | 1 | 1 | 1 | 1 | 11 | 242 |
| Music | Music | 1 | 1 | 1 | 1 | 1 | 1 | 1 | 1 | 1 | 1 | 1 | 11 | 242 |
| Sports | Sports | 2 | 2 | 2 | 2 | 2 | 2 | 2 | 2 | 2 | 2 | 2 | 22 | 484 |
| Total | Natural Science Credit | 40 | 40 | 40 | 40 | 39 | 37 | 40 | 40 | 40 | 36 | 36 | 428 | 9416 |
| | Social Science Credit | 40 | 40 | 40 | 40 | 39 | 37 | 40 | 40 | 40 | 36 | 36 | 428 | 9416 |

Note:
1. No obligatory course for the 12^{th} semester. Self-study for examination for those who want to pursue a degree. Optional courses are offered.
2. A: major/B: non-major

APPENDIX 2
High School Program (General)

| | | General Courses | | | | | | | Specialized Courses | | | Essay | | |
|---|---|---|---|---|---|---|---|---|---|---|---|---|---|---|
| | | Term | | | | | | | | | | | | |
| Field | Subject | I | II | III | IV | V | VI | VII | VIII | IX | X | XI | Credit | Hour |
| Essay | Essay | | | | | | 0 | 2 | 2 | 2 | 2 | 2 | 10 | 220 |
| | Essay Writing | | | | | | | 2 | | | | | 2 | 44 |
| Language | National Language | 4 | 4 | 4 | 4 | 4 | 4 | 4 | 4 | 4 | 4 | 4 | 44 | 968 |
| | Foreign Language | 5 | 5 | 5 | 5 | 5 | 5 | 6 | 6 | 6 | 6 | 6 | 60 | 1320 |
| | Foreign Language Writing | | | | | | 6 | 6 | 6 | 6 | 6 | 6 | 36 | 792 |
| Mathematics | Mathematics | 5 | 5 | 5 | 5 | 5 | 5 | 5 | 5 | | | | 40 | 880 |
| | Calculus | | | | | | | | | 6 | 6 | | 12 | 264 |
| Science | Fundamental Physics | 5 | 5 | 5 | 5 | 5 | | | | | | | 25 | 550 |
| | Experimental Physics | 1 | 1 | 1 | 1 | 1 | | | | | | | 5 | 110 |
| | Fundamental Chemistry | 5 | 5 | 5 | 5 | 5 | | | | | | | 25 | 550 |
| | Experimental Chemistry | 1 | 1 | 1 | 1 | 1 | | | | | | | 5 | 110 |
| | Earth Science | | | | | | 6 | | | | | | 6 | 132 |
| History/ | Fundamental History | 3 | 3 | 3 | 3 | 3 | 3 | | | | | | 18 | 396 |
| Geography | Fundamental Geography | 3 | 3 | 3 | 3 | 3 | 3 | | | | | | 18 | 396 |
| Biology/ | Fundamental Biology | | | | | | | 5 | | | | | 5 | 110 |
| Health | Life Science | | | | | | | 5 | | | | | 5 | 110 |
| | Health Education | 2 | 2 | | | | | | | | | | 4 | 88 |
| Information | Computer Science | | | | | | | 3 | | | | | 3 | 66 |
| Technology | Application Software | | | | | | | | 2 | 2 | | | 4 | 88 |
| Law | Constitution | 2 | 2 | | | | | | | | | | 4 | 88 |
| | Criminal Law | | | 2 | 2 | | | | | | | | 4 | 88 |
| | Civil Law | | | 2 | 2 | | | | | | | | 4 | 88 |
| Economics | Economics | | | | | 2 | 2 | | | | | | 4 | 88 |
| | Business Management | | | | | 2 | 2 | | | | | | 4 | 88 |
| | Financial Management | | | | | 2 | 2 | | | | | | 4 | 88 |
| Fine Arts | Fine Arts | 1 | 1 | 1 | 1 | | | | | | | | 4 | 88 |
| Music | Music | 1 | 1 | 1 | 1 | | | | | | | | 4 | 88 |
| Sports | Sports | 2 | 2 | 2 | 2 | 2 | 2 | 2 | 2 | 2 | 2 | 2 | 22 | 484 |
| Total | Semester Credit | 40 | 40 | 40 | 40 | 40 | 40 | 40 | 27 | 28 | 26 | 20 | 381 | 8382 |
| Specialized | Specialized Program | | | | | | | | ≦13 | ≦12 | ≦14 | ≦20 | ≧38 | ≧836 |
| | | | | | | | | | | | | | ≧419 | ≧9218 |

Note:
1. It is better to arrange for physics experiment and chemistry experiment at the end of class. The experiment can continue if it has not been completed after class.
2. No obligatory course for the 12^{th} semester. Self-study for examination for those who want to pursue a degree. Optional courses are offered.
3. Specialized program ≧38 credit points; comprises the basic specialized subjects of a single-discipline major.
4. High school gifted students are allowed to take upper division courses.

APPENDIX 3
High School Program (Fine Arts, Music, Sports)

| | | Specialized Courses | | | | | | | | | |
|---|---|---|---|---|---|---|---|---|---|---|---|
| | | Term | | | | | | | | | |
| Field | Subject | I | II | III | IV | V | VI | VII | VIII | IX | X |
| Elementary | Science | 4 | 4 | 4 | | | | | | | |
| Program | Social Studies | 6 | | | | | | | | | |
| | Legal Studies | 1 | 1 | 1 | | | | | | | |
| | Industry | 2 | 2 | 2 | | | | | | | |
| | Commerce | 2 | 2 | 2 | | | | | | | |
| | Information Science | 2 | 2 | 2 | | | | | | | |
| Essay | Essay | | | | | | | | | | 0 |
| | Essay Writing | | | | | | | | | | |
| Language | National Language | 6 | 6 | 6 | 4 | 4 | 4 | 4 | 4 | 4 | 4 |
| | Foreign Language | 4 | 4 | 4 | 4 | 4 | 4 | 4 | 4 | 4 | 4 |
| | Foreign Language Writing | | | | | | | 4 | 4 | 4 | 4 |
| Mathematics | Mathematics | 6 | 4 | 4 | 4 | 5 | 5 | 5 | 5 | 5 | 5 |
| | Calculus | | | | | | | | | | |
| Science | Fundamental Physics | | | | | 5 | 5 | 5 | 5 | 5 | |
| | Experimental Physics | | | | | 1 | 1 | 1 | 1 | 1 | |
| | Fundamental Chemistry | | | | | 5 | 5 | 5 | 5 | 5 | |
| | Experimental Chemistry | | | | | 1 | 1 | 1 | 1 | 1 | |
| | Earth Science | | | | | | | | | | 6 |
| History/ | Fundamental History | | 5 | 5 | 5 | 3 | | | | | |
| Geography | Fundamental geography | | 5 | 5 | 5 | 3 | | | | | |
| Biology/ | Fundamental Biology | | | | | | | | | | |
| Health | Life Science | | | | | | | | | | |
| | Health Education | | | | 4 | | | | | | |
| Information | Computer Science | | | | | | | | | | |
| Technology | Application Software | | | | | | | | | | |
| Law | Constitution | | | | 4 | | | | | | |
| | Criminal Law | | | | | 4 | | | | | |
| | Civil Law | | | | | | 4 | | | | |
| Economics | Economics | | | | | | | | | | |
| | Business Management | | | | | | | | | | |
| | Financial Management | | | | | | | | | | |
| Fine | Fine Arts/A | 0 | 0 | 0 | 0 | 0 | 0 | 0 | 0 | 0 | 0 |
| Arts | Fine Arts/B | 1 | 1 | 1 | 1 | 1 | 1 | 1 | 1 | | |
| Music | Music/A | 0 | 0 | 0 | 0 | 0 | 0 | 0 | 0 | 0 | 0 |
| | Music/B | 1 | 1 | 1 | 1 | 1 | 1 | 1 | 1 | | |
| Sports | Sports/A | 0 | 0 | 0 | 0 | 0 | 0 | 0 | 0 | 0 | 0 |
| | Sports/B | 2 | 2 | 2 | 2 | 2 | 2 | 2 | 2 | 2 | 2 |
| Credit | Fine Arts Subjects | 36 | 38 | 38 | 33 | 38 | 32 | 32 | 32 | 31 | 25 |
| Points | Music Subjects | 36 | 38 | 38 | 33 | 48 | 32 | 32 | 32 | 31 | 25 |
| | Sports Subjects | 35 | 37 | 37 | 32 | 37 | 31 | 31 | 31 | 29 | 23 |
| Fine Arts | Specialized Fine Arts | ≦4 | ≦2 | ≦2 | ≦7 | ≦2 | ≦6 | ≦8 | ≦8 | ≦9 | ≦15 |
| Music | Specialized Music | ≦4 | ≦2 | ≦2 | ≦7 | ≦2 | ≦6 | ≦8 | ≦8 | ≦9 | ≦15 |
| Sports | Specialized Sports | ≦5 | ≦3 | ≦3 | ≦8 | ≦3 | ≦7 | ≦9 | ≦9 | ≦11 | ≦17 |

| | |
|---|---|
| Specialized Courses | Essay |

Term

| Field | Subject | XI | XII | XIII | XIV | XV | Credit | Hour |
|---|---|---|---|---|---|---|---|---|
| Elementary | Science | | | | | | 12 | 264 |
| Program | Social Studies | | | | | | 6 | 132 |
| | Legal Studies | | | | | | 3 | 66 |
| | Industry | | | | | | 6 | 132 |
| | Commerce | | | | | | 6 | 132 |
| | Information Science | | | | | | 6 | 132 |
| Essay | Essay | 2 | 2 | 2 | 2 | 2 | 10 | 220 |
| | Essay Writing | 2 | | | | | 2 | 44 |
| Language | National Language | 4 | 4 | 4 | 4 | 4 | 66 | 1452 |
| | Foreign Language | 4 | 4 | 4 | 4 | 4 | 60 | 1320 |
| | Foreign Language Writing | 4 | 4 | 4 | 4 | 4 | 36 | 792 |
| Mathematics | Mathematics | 5 | 5 | | | | 58 | 1276 |
| | Calculus | | | 6 | 6 | | 12 | 264 |
| Science | Fundamental Physics | | | | | | 25 | 550 |
| | Experimental Physics | | | | | | 5 | 110 |
| | Fundamental Chemistry | | | | | | 25 | 550 |
| | Experimental Chemistry | | | | | | 5 | 110 |
| | Earth Science | | | | | | 6 | 132 |
| History/ | Fundamental History | | | | | | 18 | 396 |
| Geography | Fundamental geography | | | | | | 18 | 396 |
| Biology/ | Fundamental Biology | 3 | 2 | | | | 5 | 110 |
| Health | Life Science | 3 | 2 | | | | 5 | 110 |
| | Health Education | | | | | | 4 | 88 |
| Information | Computer Science | | 3 | | | | 3 | 66 |
| Technology | Application Software | | | 2 | 2 | | 4 | 88 |
| Law | Constitution | | | | | | 4 | 88 |
| | Criminal Law | | | | | | 4 | 88 |
| | Civil Law | | | | | | 4 | 88 |
| Economics | Economics | | | | | 4 | 4 | 88 |
| | Business Management | | | | | 4 | 4 | 88 |
| | Financial Management | | | 3 | 3 | | 6 | 132 |
| Fine | Fine Arts/A | 0 | 0 | 0 | 0 | 0 | 0 | 0 |
| Arts | Fine Arts/B | | | | | | 8 | 176 |
| Music | Music/A | 0 | 0 | 0 | 0 | 0 | 0 | 0 |
| | Music/B | | | | | | 8 | 176 |
| Sports | Sports/A | 0 | 0 | 0 | 0 | 0 | 0 | 0 |
| | Sports/B | 2 | 2 | 2 | 2 | 2 | 30 | 660 |
| Credit | Fine Arts Subjects | 29 | 28 | 27 | 29 | 22 | 470 | 10340 |
| Points | Music Subjects | 29 | 28 | 27 | 29 | 22 | 470 | 10340 |
| | Sports Subjects | 27 | 26 | 25 | 27 | 20 | 448 | 9856 |
| Fine Arts | Specialized Fine Arts | ≦11 | ≦12 | ≦13 | ≦11 | ≦18 | ≧72 | ≧1584 |
| Music | Specialized Music | ≦11 | ≦12 | ≦13 | ≦11 | ≦18 | ≧72 | ≧1584 |
| Sports | Specialized Sports | ≦13 | ≦14 | ≦15 | ≦13 | ≦17 | ≧72 | ≧1584 |
| | | | | | | Fine Arts | ≧540 | ≧11880 |
| | | | | | | Music | ≧540 | ≧11880 |
| | | | | | | Sports | ≧518 | ≧11396 |

Note:
1. It is better to arrange for physics experiment and chemistry experiment at the end of class. The experiment can continue if it has not been completed after class.
2. No obligatory course for the 12^{th} semester. Self-study for examination for those who want to pursue a degree. Optional courses are offered.
3. Note: A: major/B: non-major. Major: the first specialized subject of the master-apprentice system training.
4. Specialized program ≧72 credit points: among these, the major specialized program ≧48 credit points, the second specialized subject of the master-apprentice system training ≧24 credit points

APPENDIX 4
High School Program (Cooperative Education)

| | | General Courses | | | | | | | Specialized Courses | | | | | | | | |
|---|---|---|---|---|---|---|---|---|---|---|---|---|---|---|---|---|---|
| | | Date | | | | | | | | | | | | | | | |
| | | Start | | | | | | | | | | | | | | | |
| | | First Semester: Sep. 01-Jan. 31 | | | | | | | 03/01 | 08/01 | 10/01 | 03/01 | 05/01 | 10/01 | 12/01 | | |
| | | End | | | | | | | | | | | | | | | |
| | | Second Semester: Mar. 01-Jul. 31 | | | | | | | 07/31 | 09/30 | 02/28 | 04/30 | 09/30 | 11/30 | 04/30 | | |
| | | Term | | | | | | | | | | | | | | | |
| Field | Subject | I | II | III | IV | V | VI | VII | VIII | CE | IX | CE | X | CE | XI | Credit | Hour |
| Language | National | 4 | 4 | 4 | 4 | 4 | 4 | 4 | 4 | | 4 | | 4 | | 4 | 44 | 968 |
| | Language | | | | | | | | | | | | | | | | |
| | Foreign | 5 | 5 | 5 | 5 | 5 | 5 | 6 | 6 | | 6 | | 6 | | 6 | 60 | 1320 |
| | Language | | | | | | | | | | | | | | | | |
| | Foreign | | | | | | 6 | 6 | 6 | | 6 | | 6 | | 6 | 36 | 792 |
| | Language | | | | | | | | | | | | | | | | |
| | Writing | | | | | | | | | | | | | | | | |
| Mathematics | Mathematics | 5 | 5 | 5 | 5 | 5 | 5 | 5 | 5 | | | | | | | 40 | 880 |
| | Calculus | | | | | | | | | | 6 | | 6 | | | 12 | 264 |
| Science | Fundamental | 5 | 5 | 5 | 5 | 5 | | | | | | | | | | 25 | 550 |
| | Physics | | | | | | | | | | | | | | | | |
| | Experimental | 1 | 1 | 1 | 1 | 1 | | | | | | | | | | 5 | 110 |
| | Physics | | | | | | | | | | | | | | | | |
| | Fundamental | 5 | 5 | 5 | 5 | 5 | | | | | | | | | | 25 | 550 |
| | Chemistry | | | | | | | | | | | | | | | | |
| | Experimental | 1 | 1 | 1 | 1 | 1 | | | | | | | | | | 5 | 110 |
| | Chemistry | | | | | | | | | | | | | | | | |
| | Earth | | | | | | 6 | | | | | | | | | 6 | 132 |
| | Science | | | | | | | | | | | | | | | | |
| History/ | Fundamental | 3 | 3 | 3 | 3 | 3 | 3 | | | | | | | | | 18 | 396 |
| Geography | History | | | | | | | | | | | | | | | | |
| | Fundamental | 3 | 3 | 3 | 3 | 3 | 3 | | | | | | | | | 18 | 396 |
| | Geography | | | | | | | | | | | | | | | | |
| Biology/ | Fundamental | | | | | | | 5 | | | | | | | | 5 | 110 |
| Health | Biology | | | | | | | | | | | | | | | | |
| | Life Science | | | | | | | 5 | | | | | | | | 5 | 110 |
| | Health | 2 | 2 | | | | | | | | | | | | | 4 | 88 |
| | Education | | | | | | | | | | | | | | | | |
| Information | Computer | | | | | | | 3 | | | | | | | | 3 | 66 |
| Technology | Science | | | | | | | | | | | | | | | | |
| | Application | | | | | | | 4 | | | | | | | | 4 | 88 |
| | Software | | | | | | | | | | | | | | | | |
| Law | Constitution | 2 | 2 | | | | | | | | | | | | | 4 | 88 |
| | Criminal law | | | 2 | 2 | | | | | | | | | | | 4 | 88 |
| | Civil law | | | 2 | 2 | | | | | | | | | | | 4 | 88 |
| Economics | Economics | | | | | 2 | 2 | | | | | | | | | 4 | 88 |
| | Business | | | | | 2 | 2 | | | | | | | | | 4 | 88 |
| | Management | | | | | | | | | | | | | | | | |
| | Financial | | | | | 2 | 2 | | | | | | | | | 4 | 88 |
| | Management | | | | | | | | | | | | | | | | |
| Fine Arts | Fine Arts | 1 | 1 | 1 | 1 | | | | | | | | | | | 4 | 88 |
| Music | Music | 1 | 1 | 1 | 1 | | | | | | | | | | | 4 | 88 |
| Sports | Sports | 2 | 2 | 2 | 2 | 2 | 2 | 2 | 2 | | 2 | | 2 | | 2 | 20 | 440 |
| Total | Semester | 40 | 40 | 40 | 40 | 40 | 40 | 40 | 23 | | 24 | | 24 | | 20 | 367 | 8074 |
| | Credit | | | | | | | | | | | | | | | | |
| Specialized | Specialized | | | | | | | | ≦17 | | ≦16 | | ≦16 | | ≦20 | ≧38 | ≧836 |
| | Program | | | | | | | | | | | | | | | | |
| CE | Cooperative | | | | | | | | | 40 | | 40 | | 40 | | — | — |
| | Education | | | | | | | | | | | | | | | | |
| | | | | | | | | | | | | | | | | ≧419 | ≧9218 |

Note:
1. It is better to arrange for physics experiment and chemistry experiment at the end of class. The experiment can continue if it has not been completed after class.
2. No obligatory course for the 12^{th} semester. Self-study for examination for those who want to pursue a degree. Optional courses are offered.
3. Specialized program ≧38 credit points; comprises the basic specialized subjects of a single-discipline major.

APPENDIX 5
University and Technical College Program

| | | General Courses | | | | | | | Associated Institution | | | | |
|---|---|---|---|---|---|---|---|---|---|---|---|---|---|
| | | (Preparatory Program) | | | Specialized Courses | | | | Internship | | | | |
| | | Term | | | | | | | | | | | |
| Field | Subject | I | II | III | IV | V | VI | VII | VIII | IX | X | Credit | Hour |
| Thesis | Thesis | | | 0 | 2 | 2 | 2 | 2 | | | | 8 | 176 |
| | Thesis Writing | | | | 2 | | | | | | | 2 | 44 |
| Language | Foreign Language | 5 | 5 | 5 | | | | | | | | 15 | 330 |
| General | General Physics | 4 | 4 | 4 | | | | | | | | 12 | 264 |
| Subjects | General Chemistry | 4 | 4 | 4 | | | | | | | | 12 | 264 |
| | General History | 3 | | | | | | | | | | 3 | 66 |
| | General Geography | | 3 | | | | | | | | | 3 | 66 |
| Total | Semester Credit | 16 | 16 | 13 | 4 | 2 | 2 | 2 | | | | 55 | 1210 |
| Specialized | Specialized Program | ≦9 | ≦9 | ≦12 | ≦21 | ≦23 | ≦23 | ≦23 | ≦8 | ≦8 | ≦8 | ≧72 | ≧1584 |
| Elective | Program from Other | | | | ≦21 | ≦23 | ≦23 | ≦23 | | | | ≦32 | ≦704 |
| | Schools | | | | | | | | | | | | |
| Internship | Specialized Internship | | | | | | | | 40 | 40 | 40 | — | — |
| | | | | | | | | | | | | ≧127 | ≧2794 |

Note:
1. Experimental Physics and Experimental Chemistry are obligatory for those who take the physics program or chemistry program, and optional courses of other program are available.
2. The requirements for student to graduate from general high school:
(1) Taking at least one specialized course that is within the high school subject tests, and must not be less than 24 credit points.
(2) Including at least three specialized programs that are within the high school subject tests, and must not be less than 72 credit points.
3. The requirements for students to graduate from fine arts, music or sports high schools:
(1) Taking at least two specialized programs in specialized field, and must not be less than 48 credit points
(2) Taking at least one specialized program in a non-specialized field, and must not be less than 24 credit points
(3) Professional creation, performance and contest training is a two hour course without credit points, which can incorporate club activities, from 18:00 to 20:00
4. At the end of the third semester, a program preparatory examination will be held. The programs taken and research project participation is distributed to students according to their desire. Every school will provide students with the number of persons permitted to participate in program preparatory examinations held by other schools. The credit points of specialized program will be acknowledged.
5. The program is composed of basic courses. For a detailed specialized division, it is necessary to set up four optional subjects in the program to distinguish it as a specialized field.
6. After passing the oral exam for attaining a degree, students can report to the associated institution and start the internship.
7. During the internship in the associated institution, the students can earn at most eight credit points of courses or attend the class as an auditor by the request of a professor in the associated institution.
8. Internship in associated institution for students who pursue a master's or doctoral degree depends on what kind of professional certificate they apply for. The students pursuing a master's or doctoral degree cannot apply for a professional certificate if they have never been an intern in an associated institution of their specialized field or in an associated institution. Completing at least one of the three programs is required in order to apply for a professional certificate.
9. Students pursuing a master's or doctoral degree should take the courses on thesis/dissertation and seminar with the respective two credit points.
10. The research project team will direct and supervise the courses taken by students pursuing a bachelor's degree and allot research topics in order to achieve subordinate or innovative research targets through cooperative endeavors.
11. The research project team will direct and supervise the students pursuing a master's degree. Individual professors will suggest research direction and topics in order to achieve innovative or creative research targets through cooperative endeavors.
12. The research project team will direct and supervise the students pursuing a doctoral degree. Individual professors will suggest and research direction for the students to decide research topic in order to achieve creative research targets independently through cooperative endeavors.

APPENDIX 6
Military and Police University or College Program

| | | | | | | | | | | | | | | | Associated | | | |
|---|---|---|---|---|---|---|---|---|---|---|---|---|---|---|---|---|---|---|
| | | General Courses | | | | | | | Specialized Courses | | | | | | Institution | | | |
| | | Term | | | | | | | | | | | | | | | | |
| Field | Subject | I | II | III | IV | V | VI | VII | VIII | IX | X | XI | XII | XIII | XIV | XV | Credit | Hour |
| Thesis | Thesis | | | | | | | | | 0 | 2 | 2 | 2 | 2 | | | 8 | 176 |
| | Thesis | | | | | | | | | | 2 | | | | | | 2 | 44 |
| | Writing | | | | | | | | | | | | | | | | | |
| Language | National | 4 | 4 | 4 | 4 | | | | | | | | | | | | 16 | 352 |
| | Language | | | | | | | | | | | | | | | | | |
| | Foreign | 6 | 6 | 6 | 6 | | | | | | | | | | | | 24 | 528 |
| | Language | | | | | | | | | | | | | | | | | |
| | Foreign | 6 | 6 | 6 | 6 | | | | | | | | | | | | 24 | 528 |
| | Language | | | | | | | | | | | | | | | | | |
| | Writing | | | | | | | | | | | | | | | | | |
| Mathematics | Mathematics | 5 | | | | | | | | | | | | | | | 5 | 110 |
| | Calculus | | 6 | 6 | | | | | | | | | | | | | 12 | 264 |
| Information | Computer | 3 | | | | | | | | | | | | | | | 3 | 66 |
| Technology | Science | | | | | | | | | | | | | | | | | |
| | Application | | 2 | 2 | | | | | | | | | | | | | 4 | 88 |
| | Software | | | | | | | | | | | | | | | | | |
| General | General | | | | | 4 | 4 | 4 | | | | | | | | | 12 | 264 |
| Subjects | Physics | | | | | | | | | | | | | | | | | |
| | General | | | | | 4 | 4 | 4 | | | | | | | | | 12 | 264 |
| | Chemistry | | | | | | | | | | | | | | | | | |
| | General | | | 2 | 2 | | | | | | | | | | | | 4 | 88 |
| | History | | | | | | | | | | | | | | | | | |
| | General | | | | 2 | 2 | | | | | | | | | | | 4 | 88 |
| | Geography | | | | | | | | | | | | | | | | | |
| Combat | Physical | 0 | 0 | 0 | 0 | 0 | 0 | 0 | 0 | 0 | 0 | 0 | 0 | 0 | | | 0 | 0 |
| Training | Training | | | | | | | | | | | | | | | | | |
| | Free | 2 | 2 | 2 | 2 | 2 | 2 | 2 | | | | | | | | | 14 | 308 |
| | Combat | | | | | | | | | | | | | | | | | |
| Military | Intro to | 2 | | | | | | | | | | | | | | | 2 | 44 |
| Preparatory | Military | | | | | | | | | | | | | | | | | |
| Subjects | Affairs | | | | | | | | | | | | | | | | | |
| | Military | | 2 | | | | | | | | | | | | | | 2 | 44 |
| | Laws | | | | | | | | | | | | | | | | | |
| | Military | 2 | 2 | 0 | 0 | 0 | 0 | 0 | 0 | 0 | 0 | 0 | 0 | 0 | | | 4 | 88 |
| | Weapons | | | | | | | | | | | | | | | | | |
| | Military | | | 2 | 2 | 2 | 2 | 2 | 0 | 0 | 0 | 0 | 0 | 0 | | | 10 | 220 |
| | Tactics | | | | | | | | | | | | | | | | | |
| | Military | 10 | 10 | 10 | 10 | 10 | 10 | 10 | | | | | | | | | 70 | 1540 |
| | Training | | | | | | | | | | | | | | | | | |
| Police | Intro to | 2 | | | | | | | | | | | | | | | 2 | 44 |
| Preparatory | Police | | | | | | | | | | | | | | | | | |
| Subjects | Affairs | | | | | | | | | | | | | | | | | |
| | Police Laws | | 2 | | | | | | | | | | | | | | 2 | 44 |
| | Police | 2 | 2 | 0 | 0 | 0 | 0 | 0 | 0 | 0 | 0 | 0 | 0 | 0 | | | 4 | 88 |
| | Weapons | | | | | | | | | | | | | | | | | |
| | Police | | | 2 | 2 | 2 | 2 | 2 | 0 | 0 | 0 | 0 | 0 | 0 | | | 10 | 220 |
| | Tactics | | | | | | | | | | | | | | | | | |
| | Police | 10 | 10 | 10 | 10 | 10 | 10 | 10 | | | | | | | | | 70 | 1540 |
| | Training | | | | | | | | | | | | | | | | | |
| Total | Semester | 40 | 40 | 40 | 34 | 24 | 22 | 22 | 0 | 0 | 4 | 2 | 2 | 2 | | | 236 | 5192 |
| | Credit | | | | | | | | | | | | | | | | | |
| Specialized | Intermediate | | | | ≦6 | ≦16 | ≦18 | ≦18 | | | | | | | | | ≧36 | ≧792 |
| | Advanced | | | | | | | | ≦25 | ≦25 | ≦21 | ≦23 | ≦23 | ≦23 | ≦8 | ≦8 | ≧60 | ≧1320 |
| | Other | | | | | | | | | | ≦21 | ≦23 | ≦23 | ≦23 | | | ≧24 | ≧528 |
| | Schools | | | | | | | | | | | | | | | | | |
| Internship | Specialized | | | | | | | | | | | | | | 40 | 40 | — | — |
| | Internship | | | | | | | | | | | | | | | | | |
| | | | | | | | | | | | | | | | | | ≧356 | ≧7832 |

Note:
1. Military Forces Examination will be held at end of 7^{th} semester. Arm of the services program and research project will be distributed to the students according to their preference.
2. The Program Preparatory Examination will be held at the end of the 7^{th} semester. Police program and research project will be distributed to the students according to their preference.
3. The program is composed of basic courses. For a detailed specialized division, it is necessary to set up four optional subjects in the program to distinguish it as a specialized police field
4. Physical Fitness Training is a two hour course without credit points, from 06:00 to 08:00 every day
5. Weapon trainings should meet the following requirements:
(1) Military weapon training has no credit points; hand weapon training starts from 18:00 to 18:30 every day; heavy weapon drill is a pop test.
(2) Police weapon training has no credit points; hand weapon training is from 18:00 to 18:30 every day; heavy weapon drill is a pop test.
6. Tactics training should meet the following requirements:
(1) Military tactical training has no credit points; and consists of course reviews and pop tests.
(2) Police tactical training has no credit points; and consists of course reviews and pop tests.
7. Those who study criminal evidence as a specialty of the juridical police program can choose exemptions from physical fitness training, police weapon training and police tactical training.
8. Students should complete the military or police intermediate specialized program which totals not less than 36 credit points; students should complete at least two advanced specialized programs which total not less than 60 credit points.
9. Students should complete at least one non-military or non-police specialized program which totals not less than 24 credit points. At the end of the 9^{th} semester, national universities provide the total number of people who passed the non-specialized program examination held by the school and can be sent to other schools to study the third program. The retirement age for the armed forces or police is ten years less than the mandatory retirement age. The third program is the specialized occupation they will take up after retirement. The retirement age of armed forces or police can be unrestricted if approved by the country.
10. After passing the oral examination for the degree, students can join the armed forces, police officers or juridical police officer (including subordinate branch) and start the internship. Associated institution, chief of military forces troops, chief of armed police officers or chief of juridical police officers are all professors of military and police professional practices.
11. During internship in military troops, armed police officers and juridical police office (including subordinate branch), the students can take courses with 8 credit points or attend the class as an auditor as requested by the chief of military troops, chief of armed police officers or chief of juridical police officers.
12. Students pursuing a master's or doctoral degree should take the courses of thesis/dissertation and seminar with the respective two credit points.
13. The research project team will direct and supervise the courses taken by students pursuing the bachelor's degree and allot research topics in order to achieve subordinate or innovative research targets through cooperative endeavors.
14. The research project team will direct and supervise the students pursuing a master's degree. Individual professors will suggest research direction and topics in order to achieve innovative or creative research target through cooperative endeavors.
15. The research project team will direct and supervise the students pursuing a doctoral degree. Individual professors will suggest and guide research directions for the students to decide on the research topic in order to achieve creative research targets independently through cooperative endeavors.

### APPENDIX 7

### Remarks

### Note 1

General education is far more important than specialized education. The main reason why people do not do what they have learned is that they receive specialized education before having obtained an adequate general education, including partial academic major courses in general education courses, leading to poor learning in both types of knowledge. After entering the labor market, people find themselves more interested in other occupations because they failed to make use of their broad-based general education to correctly identify their interest and to have chosen in-depth study in specialized areas.
In the Theory of General Education and Specialized Education, the education system of elementary school places importance on diversification. Using articles in daily life, such as computer games, comics, novels, building block, cinema, scientific experiment, etc. for teaching and testing, instead of cramming teaching patterns, can increase students' learning desire and efficiency instead of reducing students' creativity and imagination which result from traditional cramming teaching methods.
The option of three programs should be provided to college and higher education students for selection of a specialized field of study.
There are three channels for entering high school and college, including admission via specialized subject test, essay competition and entrance examination.
The reasons for setting the sequence of specialized subject test, essay competition and entrance examination are as follows:
   1. Since the entrance examination is an examination in all subjects, it is a heavier burden than the other two for students, so it comes third.
   2. Regarding the sequence of specialized subject test and essay competition, essay competition comes second, because of its uncertainty and longer duration. It does not take much time to prepare a essay, but three sessions of essay presentation (school representative, second grade and first grade) and numerous participants inevitably make the duration long. Also, if the time for the specialized subject test is too close to that of the entrance examination, the students may not have enough time to prepare for the entrance examination. Consequently, it is more appropriate to hold the essay competition after specialized subject test.
   3. The reasons why specialized subject comes first are that more than half of the graduates will enter labor market every year and those who pursue degrees will value their choice for specialized field.
The goal of graduate school is to train students to do research, so the thesis has priority. Consequently, admission to a master's and doctoral degree program via thesis and via application (the Second Graduate School Application with Theses) come first and second; meanwhile, the entrance examination is the third priority for admission.

### Note 2

Possible essay topics:
   1. “Study on the reasons for poor mathematics achievement by the ◯ grade students at elementary school”
      Elementary students may be given questionnaires to investigate the mathematics learning condition of the ◯ grade students at elementary school and furthermore probe into elementary students' overall learning condition in order to improve current education, since the learning condition will be clearer from viewpoint of elementary students than simply that of teachers. The statistics analysis software developed by high school students and the questionnaire software can be used to obtain the needed statistical data.
   2. “Study on using ◯◯ comic as teaching materials for ◯ grade students”
      Let ◯ grade students read the comic; then record their responses and collect their opinions. Whatever the results suggest, whether feasible or unfeasible, what the study required was to describe the procedure and results clearly.
Others.

### Note 3

Possible essay topic: “The learning effect, on second grade students, of chapters 3, 5, 6, and 7 of the science textbook taught during the second semester.”
Others.

### Note 4

The supervisor may give students the topics regarding theoretical researches for engaging in specialized software development, theoretical research and theoretical analysis.
In an academic cooperative education program, the problems faced by enterprises may comprise the essay topic of high school students.
In a practical cooperative education program, specialized vocational training replaces the essay.

### Note 5

The students of a general university or college will have one and half years (three half years) of internship in an associated institution. The practical learning key points are “learning how to do, helping to do and doing things oneself”.
Compared to the internship of students in a general university or college, there is only one year of internship for students in a military college and police college without “learning how to do” because their training duration has covered over one and half years. After completing the internship in an associated institution, the lowest level of national registration certificate for the institution's practice category will be granted together with the diploma. The certificates granted by passing a national registration examination have several levels according to the requirements of every specialized field, to facilitate the hierarchical management and enhance the quality of professional service. As there is no shortcut for practical experience, national examination institutions should stipulate the regulations on accumulation of professional performance or time limit to optimize the national registration system.

### Note 6

The purposes/benefits of dividing high/elementary school students into classes based on capability are as follows:
   1. Classes with students with vulnerable learning ability can have two or more teachers to provide guidance and assistance to those who fall behind.
   2. To complete the phase-review.

### Note 7

The duration of the first test is long; more questions are given in the test to cover all the scopes, but with short answers. In the case of computing subjects, the questions should come from the school assignments or the exemplifications.
The duration of the second test is shorter than the first one but longer than a midterm examination; average number of questions with the difficulty level of answers equivalent to the midterm examination. In case of computing subjects, the questions should not come from the school assignments or the exemplifications, but should be equivalent to the questions of a midterm examination.

The professor can request submission in advance to avoid the situation whereby students pursuing a degree forget to bring it or lose it on the examination day.
The teacher can request submission in advance to avoid the situation whereby students pursuing a degree forget to bring it or lose it on the examination day.

### Note 8

The number of midterm examinations depends on the number of credit points; the reasons are as follows:
   1. For courses with more credits points, a midterm examination should be held a period after teaching the course. The midterm examination should not be more difficult than that of a course with lesser credit points, in order to relieve the pressure on students who are pursuing a degree.
   2. The number of midterm examinations has a positive correlation with the number of credit points. The difficulty of the examination is reduced while the teaching hours of key courses increase significantly.
   3. Courses with over five credit points are only offered in elementary school, because the course contents taught in elementary school are prone to be forgotten, so the key courses of elementary school are “national language” and “mathematics”. “Science”, “social studies”, “fine arts”, “music” and “sports” are chosen based on the interests of the students who are pursuing a degree. For students pursuing a degree, national language is the language used in daily life, mathematics knowledge is the outcome of knowledge accumulated over a long period of time and won't be forgotten with time. “Science”, “social studies”, “fine arts”, “music” and “sports” are chosen as major courses based on the interests of the students who are pursuing a degree, and these are not prone to be forgotten in the future. The non-major courses with basic credit points are to assure that the students pursuing a degree can extensively learn the necessary knowledge. The teaching materials such as comics, cinema and novels to enrich the education have sufficient attraction for the students pursuing a degree and will not be easily forgotten.
   4. The courses with more credit points are exclusively offered in elementary school to avoid too much time spent on courses which are prone to be forgotten in the future and to enhance the key courses as well as the courses chosen by students who are pursuing a degree to establish the “study value of elementary education”.

### Note 9

Those who publish a writing or dissertation at the standard of a professorial chair may fill the post of professorial chair.
Those who publish a writing or dissertation at the standard of a professor may fill the post of professor.
Those who publish a writing or thesis/dissertation at the standard of a researcher may fill the post of researcher.
The academic reputation, writing, thesis/dissertation, etc. are the index for promotion or demotion of professorial chair, professor and researcher for every two year. The assessment is decided by the research faculty. Each promotion or demotion should not be more than two levels. Exceptions for special cases may exist.
Those whose fundamental theory is disproved:
   1. A professorial chair will be demoted to professor of level eleven;
   2. A professor of level one to four will be demoted to level twelve;
   3. A professor of level five to eight will be demoted to researcher of level one;
   4. A professor of level nine to twelve will be demoted to researcher of level two;
   5. A researcher of level one and two will be demoted to level three.

### Note 10

The College Research Project Institution is an organization to release research projects, and has two types of power:
   1. To approve research projects
   2. To review the outcome of research projects

### Note 111

Ordinary teaching methods are used in college, high school and elementary school.
The key point teaching or intensive teaching is used in the specialized course of the graduate school, advanced specialized program, general high school, cooperative education program in general high school and intermediate specialized courses.
Ordinary teaching:
   1. The weekly number of teaching hours is more than the number of credit points every week, lasting to the end of the semester.
   2. The sequence of courses depends on the level of the course. Advanced courses cannot be taken until the introductory courses have been completed. It is not subject to this limitation if the professor teaching the high level course agrees that the students who have not completed the lower level courses may take the higher level courses.
   3. Ordinary teaching is for the course during a semester. Students can take several optional courses at the same time during a semester.
Key point teaching
   1. To focus on key points of the course, all the key points of the course are mentioned roughly in the first three classes. The first examination will be held immediately after the third class.
   2. Following the fourth class, the following two teaching methods are used at the same time according to the students' requirements for research or learning (professor will ask the students):
      All the students take the obligatory courses of common subjects together.
      As for specific obligatory courses, students are provided with necessary information on the course and directed individually.
   3. Key point teaching is not suitable for computing courses.
   4. Key point teaching is for the courses with continuity. One time-frame is for one course, at most two courses. The courses are connected to each other and are taught successively.
Intensive teaching
   1. The course arrangement for intensive teaching and ordinary teaching are the same. Once a course is completed, the next one should be taken immediately. Student's learning effect and concentration are much better with one time period for one course. However, intensive teaching is not suitable for mathematics or computing courses due to insufficient practice resulting from lack of time.
   2. Two courses can be taught during the same period of time.
   3. The key point of intensive teaching is to determine how much time should be given for study to students pursuing a degree, in order to yield double the result with half the effort.
   4. Intensive teaching is for the courses with continuity. There is one time-frame for one course, or at most two courses. The courses are connected to each other and are taught successively

1. The inventor gets a 0.8% royalty from the overall educational budget to build a foundation providing the funding of the research planning and the scholarship for the authorized nations' schools and students.
